(19) United States
(12) Patent Application Publication
(10) Pub. No.: US 2025/0373061 A1
(43) Pub. Date: Dec. 4, 2025

(54) VEHICLE BATTERY JUMP STARTER WITH PRE-CHARGE

(71) Applicant: MILWAUKEE ELECTRIC TOOL CORPORATION, Brookfield, WI (US)

(72) Inventors: Christopher R. Millane, Menomonee Falls, WI (US); Jacob W. Knight, Oconomowoc, WI (US); Austin A. Borkowski, Greendale, WI (US)

(21) Appl. No.: 19/219,448

(22) Filed: May 27, 2025

Related U.S. Application Data
(60) Provisional application No. 63/652,430, filed on May 28, 2024.

(51) Int. Cl. H02J 7/00; H02J 7/34

(52) U.S. Cl. CPC H02J 7/007182; H02J 7/0031; H02J 7/0048; H02J 7/005; H02J 7/0063; H02J 7/00714; H02J 7/007194; H02J 7/342; H02J 7/345; H02J 2207/50

(57) ABSTRACT

A device may include a first controller including a first electronic processor and a charge control circuit. The device may include a battery pack interface configured to receive a removable and rechargeable battery pack. The device may include a power boost module including one or more energy storage devices, wherein the power boost module is configured to be charged through the battery pack interface with a discharge current from the removable and rechargeable battery pack in response to receiving the removable and rechargeable battery pack in the battery pack interface, wherein the charge control circuit is configured to control the discharge current from the removable and rechargeable battery pack to the power boost module based upon one or more monitored conditions of the removable and rechargeable battery pack.

### BACKGROUND

The present technology relates to a vehicle battery jump starter powered by a removable and rechargeable battery pack.

### SUMMARY

Vehicle battery jump starters are subject to a number of design limitations that make the implementation of a vehicle battery jump starter difficult. For example, the vehicle battery jump starter must satisfy requirements related to voltage magnitudes (e.g., vehicle battery overvoltage), power source undervoltage (e.g., jump starter power source undervoltage), sparking and short circuiting, and electrical current magnitude. As a result of these limitations, current vehicle battery jump starters are dedicated devices with internal power sources that can be charged and then used as necessary to jump start a vehicle. These jump starters may include a sealed lead acid battery, a plurality of lithium polymer batteries, or a bank of supercapacitors. Such devices are often charged from AC mains power. However, because AC mains power is not always readily available, it is possible that, in an emergency, the vehicle battery jump starters may lack sufficient charge to jump start a vehicle battery. A depleted vehicle battery can be used to slowly charge a bank of supercapacitors, but the bank of supercapacitors alone may not always be sufficient to jump start the vehicle battery.

As an alternative to these conventional vehicle battery jump starters, a vehicle battery jump starter that could be powered by a battery pack for cordless, hand-held power tools would greatly enhance the versatility of vehicle battery jump starters. Such a jump starter could be used anywhere at any time as long as a battery pack is available. One of the difficulties in implementing a vehicle battery jump starter powered by a battery pack for power tools is the magnitude of current that the battery pack is capable of producing. Electrical current limitations of battery packs in the context of vehicle battery jump starters can be mitigated or removed if the battery pack is first used to charge a bank of supercapacitors or lithium polymer battery cells. After the supercapacitors or lithium polymer battery cells are charger, current can be discharged from both the battery pack and the supercapacitors or lithium polymer battery cells. The battery pack discharge current in combination with discharge current from the supercapacitors or lithium polymer battery cells can be sufficient to jump start a vehicle battery. In some situations, just as a depleted vehicle battery can be used to charge a bank of supercapacitors, a depleted battery pack could be used alone or in conjunction with a depleted vehicle battery to charge the bank of supercapacitors. The bank of supercapacitors could then be used to attempt to jump start the vehicle battery.

Before any embodiments of the invention are explained in detail, it is to be understood that the invention is not limited in its application to the details of the configuration and arrangement of components set forth in the following description or illustrated in the accompanying drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processing units, such as an electronic processor, a microprocessor and/or application specific integrated circuits (“ASICs”). As such, it should be noted that a plurality of hardware and software-based devices, as well as a plurality of different structural components may be utilized to implement the invention. For example, “servers” and “computing devices” described in the specification can include one or more processing units, one or more computer-readable medium modules, one or more input/output interfaces, and various connections (e.g., a system bus) connecting the components.

In some aspects, the techniques described herein relate to a vehicle battery jump starter including a controller including an electronic processor and a charge control circuit, a battery pack interface configured to receive a removable and rechargeable battery pack, and a power boost module including one or more energy storage devices, wherein the power boost module is configured to be charged through the battery pack interface with a discharge current from the removable and rechargeable battery pack in response to receiving the removable and rechargeable battery pack, and wherein the charge control circuit is configured to control the discharge current from the removable and rechargeable battery pack to the power boost module based upon one or more monitored conditions of the removable and rechargeable battery pack.

In some aspects, the techniques described herein relate to a vehicle battery jump starter, wherein the charge control circuit is configured to control the discharge current from the battery pack to prevent the battery pack from being discharged below a predetermined voltage threshold.

In some aspects, the techniques described herein relate to a vehicle battery jump starter, wherein the charge control circuit is configured to determine a no-load voltage of the battery pack and calculate an allowable load voltage for the battery pack based on the no-load voltage.

In some aspects, the techniques described herein relate to a vehicle battery jump starter, wherein the charge control circuit is configured to monitor a voltage of the battery pack during discharge and modulate the discharge current to maintain the battery voltage at or above an predetermined voltage threshold.

In some aspects, the techniques described herein relate to a vehicle battery jump starter, wherein the vehicle battery jump starter includes a communication line for providing a communication link between the controller and the battery pack.

In some aspects, the techniques described herein relate to a vehicle battery jump starter, wherein the controller is further configured to prevent the battery pack from discharging a current when a voltage of the battery pack is below a predetermined threshold or when discharging current would drop the voltage below the predetermined voltage threshold.

In some aspects, the techniques described herein relate to a vehicle battery jump starter, wherein the charge control circuit is configured to determine the predetermined threshold based on an impedance level of the battery pack.

In some aspects, the techniques described herein relate to a vehicle battery jump starter, wherein the charge control circuit is configured to optimize the discharge current based on information including a battery pack capacity, a battery pack impedance, a state of charge of the battery pack, a state of health of the battery pack, or a temperature of the battery pack.

In some aspects, the techniques described herein relate to a vehicle battery jump starter, wherein the charge control circuit is configured to: monitor a discharge characteristic of the battery pack, determine an optimal discharge rate for the battery pack, and control the battery pack based upon the optimal discharge rate.

In some aspects, the techniques described herein relate to a vehicle battery jump starter, wherein the monitored conditions include a prediction of battery behavior based upon a machine learning profile containing historical data from a previous use of the battery pack.

In some aspects, the techniques described herein relate to a vehicle battery jump starter, wherein the controller is configured to reduce power draw of the power boost module based on a voltage of the battery pack during discharge.

In some aspects, the techniques described herein relate to a vehicle battery jump starter, further including a user input module configured to receive an instruction to charge the power boost module prior to connection to a vehicle battery.

In some aspects, the techniques described herein relate to a vehicle battery jump starter, wherein the controller is configured to electrically connect the battery pack to the power boost module and to electrically disconnect the battery pack from the power boost module after the power boost module is fully charged.

In some aspects, the techniques described herein relate to a method of operating a vehicle battery jump starter, the method including attaching a removable and rechargeable battery pack to a vehicle battery jump starter, receiving a user input at the vehicle battery jump starter to charge a power boost module using energy from the battery pack, charging, via an electronic processor, the power boost module with energy from the battery pack in response to the user input, connecting the vehicle battery jump starter to a vehicle battery via terminal clamps, controlling, via the electronic processor, the power boost module to allow power to be provided from the power boost module to the vehicle battery, and in response to receiving a user input to provide power to the vehicle battery, evaluating, via the electronic processor, one or more parameters of the vehicle battery jump starter, the one or more parameters including at least one of: a charge state of the power boost module and a connection to the vehicle battery, and in response to the power boost module being in a charged state and the vehicle battery being in a connected state, providing power from the vehicle battery jump starter to the vehicle battery to enable an attempt to start the vehicle.

In some aspects, the techniques described herein relate to a method, wherein evaluating the one or more parameters includes determining whether the vehicle battery jump starter is electrically connected to the vehicle battery via the terminal clamps and evaluating a charge state of the power boost module to determine that the power boost module is charged.

In some aspects, the techniques described herein relate to a method, further including: monitoring, via the electronic processor, a voltage of the battery pack during charging of the power boost module, determining, via the electronic processor, that the power boost module is fully charged prior to disconnecting the battery pack from the power boost module, and disconnecting, via the electronic processor, the battery pack from the power boost module after charging the power boost module.

In some aspects, the techniques described herein relate to a system for jump starting a vehicle battery, the system including a removable and rechargeable battery pack including a plurality of battery cells and a battery controller configured to monitor one or more battery conditions, a vehicle battery jump starter including a battery pack interface configured to receive and electrically connect to the removable and rechargeable battery pack, the vehicle battery jump starter further including a power boost module, an electronic processor, and a charge control circuit, wherein the electronic processor of the vehicle battery jump starter is configured to: receive, via the battery pack interface, the connection of the removable and rechargeable battery pack, receive battery condition data from the battery controller via a communication link between the battery pack and the jump starter, determine a no-load voltage of the battery pack and calculate a voltage threshold based on the no-load voltage and an impedance of the battery pack, control a discharge current from the battery pack to the power boost module based on the voltage threshold and the one or more battery conditions, monitor the voltage of the battery pack during charging of the power boost module and modulate the discharge current to maintain the battery pack voltage at or above the voltage threshold, and prevent discharge from the battery pack in response to the voltage of the battery pack being below the voltage threshold.

In some aspects, the techniques described herein relate to a system, further including a precharge circuit configured to selectively connect or disconnect the battery pack from the power boost module.

In some aspects, the techniques described herein relate to a system, wherein the charge control circuit is further configured to calculate the voltage threshold for the battery pack based on the no-load voltage and to limit the discharge current to maintain the battery pack voltage above the voltage threshold.

In some aspects, the techniques described herein relate to a system, wherein the electronic processor is further configured to determine a performance level of the connected battery pack, the performance level including a high-performance or low-performance, where the determination is based on a battery pack impedance, and control a discharge current from the battery pack to the power boost module based on the voltage threshold and the performance level of the battery pack.

Other aspects of the invention will become apparent by consideration of the detailed description and accompanying drawings.

### BRIEF DESCRIPTION OF THE DRAWINGS

FIG. 1 is a perspective view of a battery pack, according to some embodiments.

FIG. 2 is a top view of the battery pack of FIG. 1, according to some embodiments.

FIG. 3 is a section view of the battery pack of FIG. 1 showing battery cells, according to some embodiments.

FIG. 4 is an electromechanical diagram of the battery pack of FIG. 1, according to some embodiments.

FIG. 5 illustrates a vehicle battery jump starter configured to receive, support, and be powered by the battery pack of FIG. 1, according to some embodiments.

FIG. 6 is an electromechanical diagram of the vehicle battery jump starter of FIG. 5, according to some embodiments.

FIG. 7 is a process for jump starting a vehicle battery using the vehicle battery jump starter of FIG. 5 being powered by the battery pack of FIG. 1, according to some embodiments.

FIG. 8 is a process for jump starting a vehicle battery using the vehicle battery jump starter of FIG. 5 being powered by the battery pack of FIG. 1, according to some embodiments.

### DETAILED DESCRIPTION

This technology relates to a vehicle battery jump starter that is powered by a removable and rechargeable battery pack, such as a battery pack used with various hand-held power tools. The battery pack removably connects to a vehicle battery jump starter. The battery pack, or a plurality of battery packs connected together, can be used to power the vehicle battery jump starter and jump start a vehicle battery. The battery pack can also be selectively used to charge a power boost module within the vehicle battery jump starter. The power boost module includes, for example, a plurality of supercapacitors or lithium polymer battery cells. The power boost module in combination with the removable and rechargeable battery pack are used to jump start a vehicle battery.

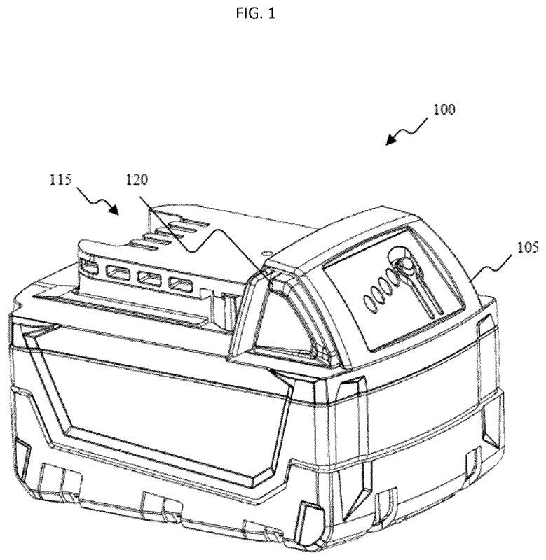

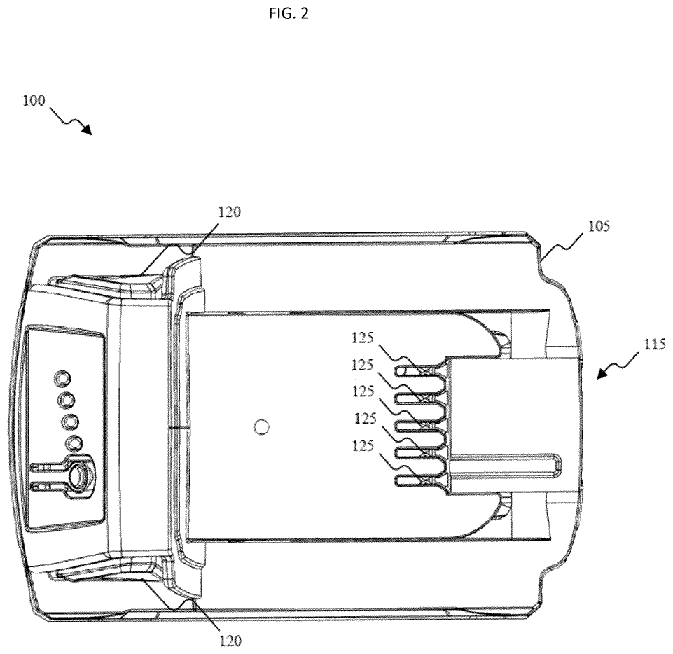

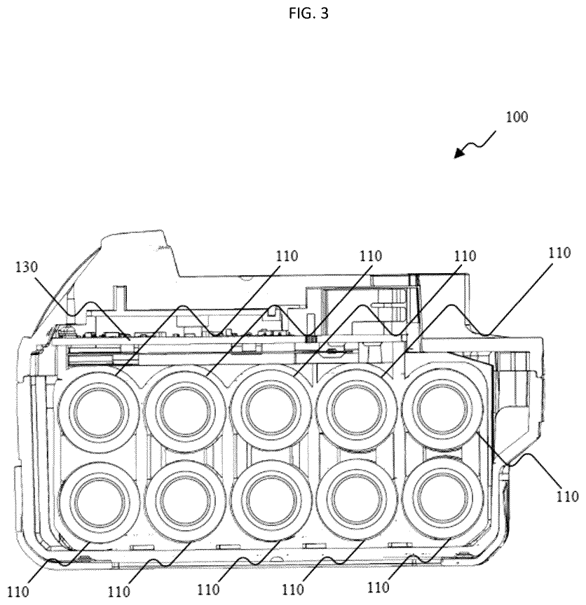

FIGS. 1-3 illustrate a battery pack 100 for use with a vehicle battery jump starter. The battery pack 100 is connectable to and supportable by hand-held power tools such as drills, fasteners, saws, pipe cutters, sanders, nailers, staplers, vacuum cleaners, etc. The battery pack 100 is also connectable to and supportable by outdoor power tools such as string trimmers, hedge trimmers, blowers, chain saws, etc. As shown in FIGS. 1-3, the battery pack 100 includes a housing 105 and at least one rechargeable battery cell 110 (shown in FIG. 3) supported by the housing 105. The battery pack 100 also includes a support portion 115 for supporting the battery pack 100 on a tool, and a coupling mechanism 120 for selectively coupling the battery pack 100 to, or releasing the battery pack 100 from, the tool. The support portion 115 is connectable to a complementary support portion on the tool.

The battery pack 100 includes a plurality of terminals 125 located within the support portion 115 and operable to electrically connect the battery cells 110 to a PCB 130 within the battery pack 100. The plurality of terminals 125 includes, for example, a positive battery terminal, a ground terminal, and a sense or data terminal. The battery pack 100 is removably and interchangeably connected to a tool to provide operational power to the tool. The terminals 125 are configured to mate with corresponding power terminals extending from a tool within a complementary receiving portion or the tool.

The illustrated battery pack 100 includes ten battery cells 110. In other embodiments, the battery pack 100 can include additional or fewer battery cells 110. The battery cells can be arranged in series, parallel, or a series-parallel combination. For example, the battery pack can include a total of ten battery cells configured in a series-parallel arrangement of five sets of two series-connected cells. The series-parallel combination of battery cells allows for an increased voltage and an increased capacity of the battery pack. In some embodiments, the battery pack 100 includes five series-connected battery cells. In other embodiments, the battery pack 100 includes a different number of battery cells (e.g., between three and thirty battery cells) connected in series, parallel, or a series-parallel combination in order to produce a battery pack having a desired combination of nominal battery pack voltage and battery capacity.

The battery cells 110 are lithium-based battery cells having a chemistry of, for example, lithium-cobalt (“Li—Co”), lithium-manganese (“Li—Mn”), or Li—Mn spinel. In some embodiments, the battery cells 110 have other suitable lithium or lithium-based chemistries, such as a lithium-based chemistry that includes manganese, etc. The battery cells within the battery pack 100 provide operational power (e.g., voltage and current) to the tools. In one embodiment, each battery cell 110 has a nominal voltage of approximately 3.6V, such that the battery pack has a nominal voltage of approximately 18V. In other embodiments, the battery cells have different nominal voltages, such as, for example, between 3.6V and 4.2V, and the battery pack has a different nominal voltage, such as, for example, 10.8V, 12V, 14.4V, 24V, 28V, 36V, 60V, 80V, between 10.8V and 80V, etc. The battery cells 110 also each have a capacity of, for example, approximately between 1.0 ampere-hours (“Ah”) and 6.0 Ah. In exemplary embodiments, the battery cells each have capacities of approximately, 1.5 Ah, 2.4 Ah, 3.0 Ah, 4.0 Ah, 6.0 Ah, between 1.5 Ah and 6.0 Ah, etc. In some embodiments, a battery pack 100 having a total battery pack capacity of approximately 5.0 Ah or greater (e.g., 5.0 Ah to 12.0 Ah) is used in combination with a vehicle battery jump starter. In other embodiments, a battery pack 100 having a total battery pack capacity of approximately 1.5 Ah or greater (e.g., 1.5 Ah to 12.0 Ah) is used in combination with a vehicle battery jump starter.

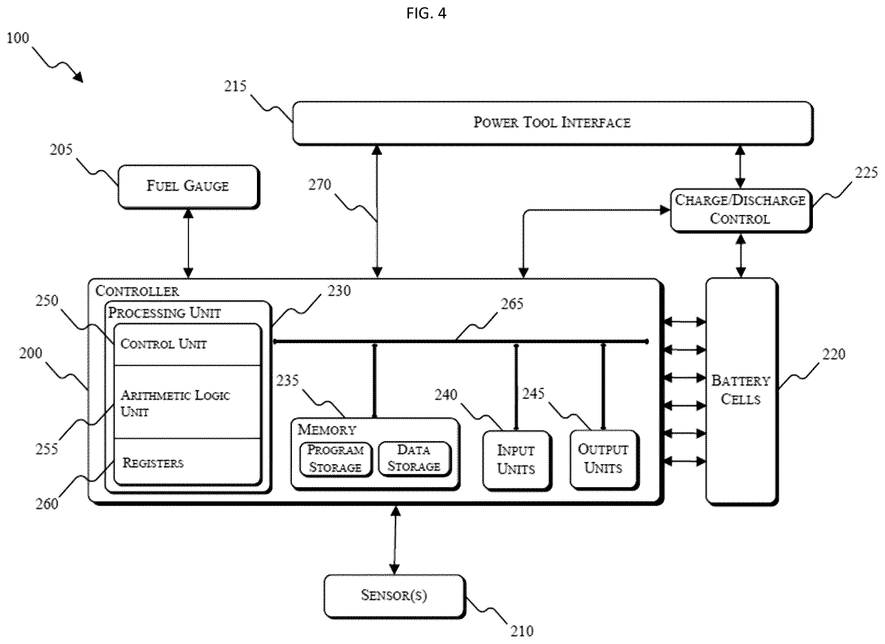

The power output by the battery pack 100 to a tool is controlled, monitored, and regulated using control electronics within the battery pack 100, a tool, or a combination thereof. FIG. 4 illustrates a controller 200 associated with the battery pack 100. The controller 200 is electrically and/or communicatively connected to a variety of modules or components of the battery pack 100. For example, the illustrated controller 200 is connected to a fuel gauge 205, one or more sensors 210, a tool interface 215, a plurality of battery cells 220, and a charge/discharge control module 225 (optional within battery pack). The controller 200 includes combinations of hardware and software that are operable to, among other things, control the operation of the battery pack 100, activate the fuel gauge 205, monitor the operation of the battery pack 100, etc. The fuel gauge 205 includes, for example, one or more indicators, such as light-emitting diodes (“LEDs”). The fuel gauge 205 can be configured to display conditions of, or information associated with, the state-of-charge of the battery cells 220. The controller 200 also includes a variety of preset or calculated fault condition values related to temperatures, currents, voltages, etc., associated with the operation of a tool.

In some embodiments, the controller 200 includes a plurality of electrical and electronic components that provide power, operational control, and protection to the components and modules within the controller 200 and/or battery pack 100. For example, the controller 200 includes, among other things, a processing unit 230 (e.g., an electronic processor, a microprocessor, a microcontroller, or another suitable programmable device), a memory 235, input units 240, and output units 245. The processing unit 230 includes, among other things, a control unit 250, an arithmetic logic unit (“ALU”) 255, and a plurality of registers 260 (shown as a group of registers in FIG. 4), and is implemented using a known computer architecture, such as a modified Harvard architecture, a von Neumann architecture, etc. The processing unit 230, the memory 235, the input units 240, and the output units 245, as well as the various modules connected to the controller 200 are connected by one or more control and/or data buses (e.g., common bus 265). The control and/or data buses are shown generally in FIG. 4 for illustrative purposes. The use of one or more control and/or data buses for the interconnection between and communication among the various modules and components would be known to a person skilled in the art in view of the technology described herein. In some embodiments, the controller 200 is implemented partially or entirely on a semiconductor (e.g., a field-programmable gate array [“FPGA”] semiconductor) chip, such as a chip developed through a register transfer level (“RTL”) design process.

The memory 235 is a non-transitory computer readable medium that includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 230 is connected to the memory 235 and executes software instructions that are capable of being stored in a RAM of the memory 235 (e.g., during execution), a ROM of the memory 235 (e.g., on a generally permanent basis), or another non-transitory computer readable medium such as another memory or a disc. Software included in the implementation of the battery pack 100 can be stored in the memory 235 of the controller 200. The software includes, for example, firmware, one or more applications, program data, filters, rules, one or more program modules, and other executable instructions. The controller 200 is configured to retrieve from memory and execute, among other things, instructions related to the control of the battery pack described herein. The controller 200 can also store various battery pack parameters and characteristics (including battery pack nominal voltage, chemistry, battery cell characteristics, maximum allowed discharge current, maximum allowed temperature, etc.). In other constructions, the controller 200 includes additional, fewer, or different components.

The tool interface 215 includes a combination of mechanical components (e.g., the support portion 115) and electrical components (e.g., the plurality of terminals 125) configured to, and operable for, interfacing (e.g., mechanically, electrically, and communicatively connecting) the battery pack 100 with a tool or another device. For example, power provided from the battery pack 100 to a tool or device is provided through the charge/discharge control module 225 to the tool interface 215. The charge/discharge control module 225 includes, for example, one or more switches (e.g., FETs) for controlling the charging current to and discharge current from the battery cells 220. In some embodiments, power provided from the battery pack 100 to a tool or device (or from a charger) is controlled by a charge/discharge control module 225 that is external to the battery pack 100 (i.e., internal to a tool, device, or charger). The tool interface 215 also includes, for example, a communication line 270 for providing a communication line or link between the controller 200 and a tool or device (e.g., a vehicle battery jump starter).

The sensors 210 include, for example, one or more current sensors, one or more voltage sensors, one or more temperature sensors, etc. For example, the controller 200 uses the sensors 210 to monitor an individual state of charge of each of the battery cells 220, monitor a current being discharged from the battery cells 220, monitor the temperature of one or more of the battery cells 220, etc. If the voltage of one of the battery cells 220 is equal to or above an upper voltage limit (e.g., a maximum charging voltage), the charge/discharge control module 225 prevents the battery cells from being further charged or requests that a battery charger (not shown) provide a constant voltage charging scheme. Alternatively, if one of the battery cells 220 falls below a low-voltage limit, the charge/discharge control module prevents the battery cells 220 from being further discharged. Similarly, if an upper or lower operational temperature limit for the battery cells 220 is reached, the controller 200 can prevent the battery pack 100 from being charged or discharged until the temperature of the battery cells 220 or the battery pack 100 is within an acceptable temperature range.

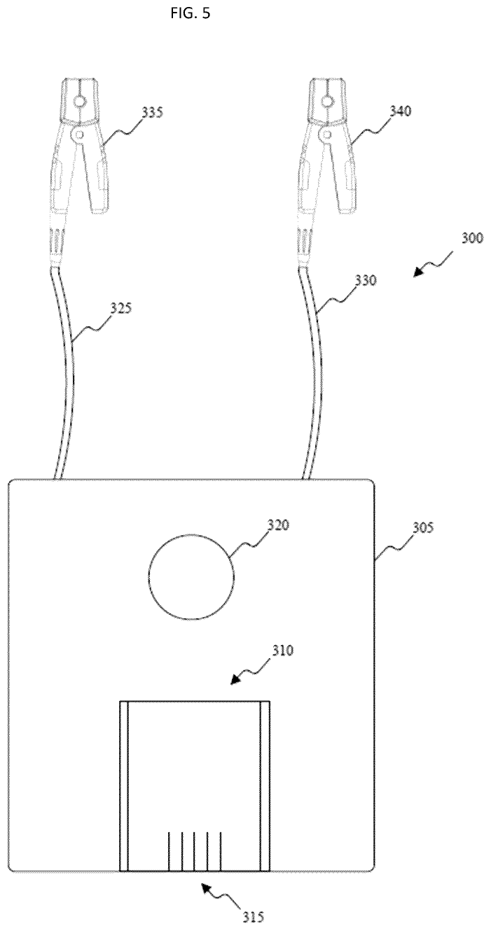

The battery pack 100 is connectable to and supportable by a vehicle battery jump starter such as vehicle battery jump starter 300 illustrated in FIG. 5. The vehicle battery jump starter 300 includes a housing 305, a support portion 310 for receiving and supporting the battery pack 100, a plurality of terminals 315 for electrically connecting the battery pack 100 to the vehicle battery jump starter 300, an ON or POWER button 320 for turning ON or activating the vehicle battery jump starter 300, a first electrical cable 325, a second electrical cable 330, a first terminal clamp 335, and a second terminal clamp 340. The battery pack 100 connects to the vehicle battery jump starter 300 through the support portion 310 and the plurality of terminals 315. As a result, the battery pack 100 operates as a power source for the vehicle battery jump starter 300.

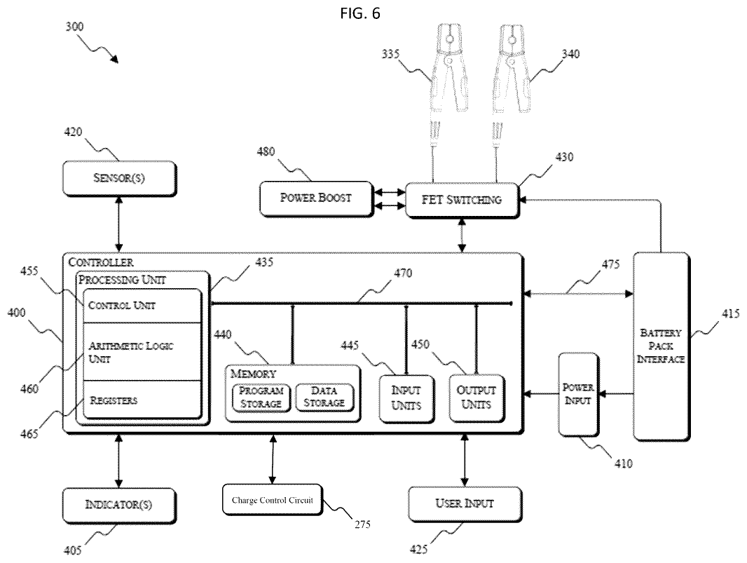

The vehicle battery jump starter 300 includes a controller 400, as shown in FIG. 6. The controller 400 is electrically and/or communicatively connected to a variety of modules or components of the vehicle battery jump starter 300. For example, the illustrated controller 400 is connected to one or more indicators 405, a power input module 410, a battery pack interface 415, one or more sensors 420, a user input module 425, and a FET switching module 430. The controller 400 includes combinations of hardware and software that are operable to, among other things, control the operation of the vehicle battery jump starter 300, activate the one or more indicators 405 (e.g., an LED), monitor the operation of the vehicle battery jump starter 300, etc. The one or more sensors 420 include, among other things, one or more voltage sensors, one or more current sensors, one or more temperature sensors, etc.

In some embodiments, the controller 400 includes a plurality of electrical and electronic components that provide power, operational control, and protection to the components and modules within the controller 400 and/or vehicle battery jump starter. For example, the controller 400 includes, among other things, a processing unit 435 (e.g., a microprocessor, a microcontroller, or another suitable programmable device), a memory 440, input units 445, and output units 450. The processing unit 435 includes, among other things, a control unit 455, an ALU 460, and a plurality of registers 465 (shown as a group of registers in FIG. 6), and is implemented using a known computer architecture, such as a modified Harvard architecture, a von Neumann architecture, etc. The processing unit 435, the memory 440, the input units 445, and the output units 450, as well as the various modules connected to the controller 400 are connected by one or more control and/or data buses (e.g., common bus 470). The control and/or data buses are shown generally in FIG. 6 for illustrative purposes. The use of one or more control and/or data buses for the interconnection between and communication among the various modules and components would be known to a person skilled in the art in view of the technology described herein. In some embodiments, the controller 400 is implemented partially or entirely on a semiconductor (e.g., an FPGA semiconductor) chip.

The memory 440 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 435 is connected to the memory 440 and executes software instructions that are capable of being stored in a RAM of the memory 440 (e.g., during execution), a ROM of the memory 440 (e.g., on a generally permanent basis), or another non-transitory computer readable medium such as another memory or a disc. Software included in the implementation of the vehicle battery jump starter can be stored in the memory 440 of the controller 400. The software includes, for example, firmware, one or more applications, program data, filters, rules, one or more program modules, and other executable instructions. The controller 400 is configured to retrieve from memory and execute, among other things, instructions related to the control processes and methods described herein. In other constructions, the controller 400 includes additional, fewer, or different components.

The battery pack interface 415 includes a combination of mechanical components (e.g., the support portion 310) and electrical components (e.g., the plurality of terminals 315) configured to and operable for interfacing (e.g., mechanically, electrically, and communicatively connecting) the vehicle battery jump starter with the battery pack 100. For example, power provided by the battery pack 100 to the vehicle battery jump starter is provided through the battery pack interface 415 to a power input module 410. The power input module 410 includes combinations of active and passive components to regulate or control the power received from the battery pack 100 prior to power being provided to the controller 400. The battery pack interface 415 also includes, for example, a communication line 475 for providing a communication line or link between the controller 400 and the battery pack 100. The battery pack interface 415 supplies power to the FET switching module 430 to be switched by the switching FETs to selectively provide power to the clamps 335, 340. The FET switching module 430 is also connected to a power boost module 480. The power boost module 480 includes, for example, a plurality of supercapacitors or lithium-polymer battery cells. The power boost module 480 is selectively charged by the controller 400 with power from the battery pack 100. In some embodiments, the power boost module 480 is charged by a vehicle battery (e.g., supercapacitors can be charged from a depleted vehicle battery). The power boost module 480 can be used in conjunction with the battery pack 100 to provide power to a vehicle battery to jump start the vehicle battery. In some embodiments, the power boost module 480 alone (i.e., without battery pack 100) can be used to attempt to jump start a vehicle battery. Without the battery pack 100, however, the capabilities of the vehicle battery jump starter 300 are limited. For example, supercapacitors alone may not have the energy capacity to jump start a vehicle without the battery pack 100. Alternatively, lithium polymer battery cells require charging which may be difficult or impossible depending upon the location of the vehicle when its battery needs to be jump started.

In some embodiments, the vehicle battery jump starter 300 may include optimization features configured to be implemented by a charge control circuit 275. For example, before current is discharged from the battery pack 100, the charge control circuit 275 measures one or more parameters of the battery pack 100. In one embodiment, the parameter is a no-load voltage of the battery pack 100, which may be determined using, for example, the sensor 210. The measured battery pack voltage is then used by the charge control circuit 275 to calculate an allowable load voltage (also referred to as a threshold or a predetermined threshold) for the battery pack 100 when being discharged by the charge control circuit 275. In some examples the allowable load voltage is a predetermined voltage level.

In response to the allowable load being determine, the charge control circuit 275 then controls the vehicle battery jump starter 300 to draw current from the battery pack 100 until the allowable load level is reached. In some examples, the load level is determined based on a voltage drop during discharge. The charge control circuit 275 may prevent the vehicle battery jump starter 300 from drawing a current that would cause an undesired drop in voltage of the battery pack 100, e.g., below the load voltage threshold. In some embodiments, the charge control circuit 275 continues to measure the voltage of the battery pack 100 during discharge and modulates the discharge current in order to maintain the battery voltage at or above the allowable load voltage threshold. In some embodiments, the functions of the charge control circuit 275 are performed by the controller 400.

In some instances, the charge control circuit 275 may calculate the allowable load voltage threshold, or control the discharging of the battery pack 100, based upon the type of battery pack 100 connected. For example, when a low performing battery (e.g., a battery with high impedance) is connected to the vehicle battery jump starter 300, the allowable voltage threshold may be reached with a lower overall discharge current. On the other hand, when a high performing battery (e.g., a battery with low impedance) is connected to the vehicle battery jump starter 300, the allowable voltage threshold may be reached with a higher overall discharge current. In other words, a low performing battery pack may produce an overall lower discharge current, and therefore a longer charging time, than a high performing battery pack. The charge control circuit 275 is configured to control the vehicle battery jump starter 300 in order to maximize the efficiency of the connected battery pack 100, regardless of its performance level. In some examples, battery information, such as impedance, capacity, state of health, state of charge, temperature, etc., may be communicated by the battery controller 200 to the vehicle battery jump starter 300. In other examples, the battery information may be determined by the controller 400 and/or charge control circuit 275 upon the battery pack 100 being electrically coupled to the vehicle battery jump starter 300.

In some embodiments, the vehicle battery jump starter 300 may function as a charging device when connected with the battery pack 100. For example, the controller 400 of the vehicle battery jump starter 300 may be configured to communicate with the controller 200 of the battery pack to obtain battery specific information. The battery specific information may be, for example, a battery capacity level, an impedance level, a battery age, a battery temperature, a battery voltage level, or historical data such as a number of battery charge/discharge cycles, number of battery usages, or a number of battery overtemperature events. Once the battery specific information is obtained by the controller 400, the charge control circuit 275 may use some or all of the battery specific information to calculate an appropriate discharge current. For instance, as previously described, high/low performing batteries may have different impedance levels. The charge control circuit 275 may calculate the appropriate discharge current (and therefore the predetermined load voltage level) based upon the battery specific impedance level obtained from the battery pack 100.

In some embodiments, the vehicle battery jump starter 300 is configured to monitor characteristics of the battery pack 100 during operation. For example, the charge control circuit 275 is configured to monitor discharge characteristics of the battery pack 100 during operation of the vehicle battery jump starter 300 in order to predict behavior. In other words, the monitored characteristics are used by the charge control circuit 275 to determine optimal discharge rates for the battery pack 100. This prediction may also be used to determine whether the selected battery pack operates at a high-performance level or a low-performance level (e.g., high or low impedance battery). Additionally, the charge control circuit 275 may use the predicted behavior to modulate the discharge rate of the battery pack 100. In some instances, the prediction utilizes machine learning to create a prediction profile for the battery pack 100. The prediction profile may contain historical data from previous uses of the battery pack 100 and is used by the charge control circuit 275 to determine the capabilities of the battery pack (e.g., the optimal discharge rates, the allowable voltage threshold, and the like).

In some embodiments, the vehicle battery jump starter 300 is configured to monitor the voltage level of the battery pack 100, as previously described, and adjusts the performance of elements within the vehicle battery jump starter 300 based upon the voltage of the battery pack 100 during discharge. For example, in response to the monitored voltage of the battery pack 100 being below the allowable voltage threshold, as previously described, the controller 400 may reduce power draw, extend a run time, modify performance of the power boost module 480, or perform other operations as required for a given application. In some examples, the combination is referred to as a system for jump starting a vehicle battery.

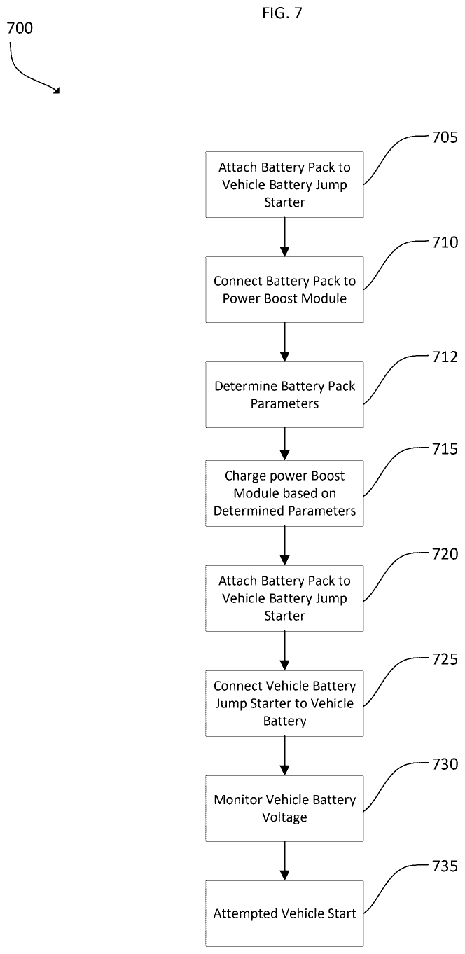

FIG. 7 is operation of the combination of battery pack 100 and vehicle battery jump starter 300. A process 700 begins with the battery pack 100 being attached to the vehicle battery jump starter 300 (at 705). Following STEP 705, the controller 400 of the vehicle battery jump starter 300 controls the precharge circuit 505 to electrically connect the battery pack 100 to the power boost module 480 (at 710). After the battery pack 100 is connected to the power boost module 480, one or more parameters of the connected battery pack 100 are determined (at 712) as described in more detail above. Upon determining the parameters of the battery pack 100, stored energy from the battery pack 100 can be used to charge the power boost module 480 (at 715) based upon the determined parameters. In some embodiments, the charge control circuit 275 regulates the current discharged from the battery pack 100 as previously described. After the power boost module 480 has been fully charged, the controller 400 controls the precharge circuit 505 to electrically disconnect the battery pack 100 from the power boost module 480 (at 720). With the power boost module 480 charged and the battery pack 100 connected to the vehicle battery jump starter 300, the combination of the battery pack 100 and the vehicle battery jump starter can be used to jump start the vehicle battery 500.

The charge control circuit 275 can selectively prevent the battery pack 100 from being used to jump start the vehicle battery 500 if the voltage of the battery pack 100 is so low that attempting to jump start the vehicle battery 500 could damage the battery pack 100. For example, in addition to the allowable voltage threshold of the battery pack 100, a second allowable voltage threshold value can be implemented to prevent the battery pack 100 from being used to jump start a vehicle. In some examples, the charge control circuit 275 may prevent the battery pack 100 from discharging current when the battery pack 100′s voltage is below the second threshold value and discharging current would drop the voltage of the battery pack 100 below the second allowable voltage threshold (e.g., 2.6V per cell). The second voltage threshold value is selected to correspond to the amount of energy required to jump start the vehicle battery 500 or an expected voltage reduction resulting from the discharge of the high current necessary to jump start a vehicle battery. If the battery pack 100 has less charge than would be required to jump start the vehicle battery 500 and attempting to jump start the vehicle battery 500 would cause the battery pack 100's voltage to be depleted below or fall below the standard low-voltage cutoff, charge control circuit 275 prevents the battery pack 100 from attempting to jump start the vehicle battery 500. In some embodiments, the controller 400 of the vehicle battery jump starter 300 or the controller 200 of the battery pack 100 may perform these features.

The vehicle battery jump starter 300 is then connected to the vehicle battery 500 via terminal clamps 335 and 340 (at 725). Once the vehicle battery jump starter 300 is connected to the vehicle battery 500, the controller 400 monitors the voltage across the vehicle battery 500 (at 730). When an attempt to start a vehicle is made, the voltage of the vehicle battery 500 is reduced. This reduction in voltage of the vehicle battery 500 signals to the controller 400 that an attempt to start the vehicle has been made (at 735).

FIG. 7 is a flowchart illustrating an operation of the combination of battery pack 100 and vehicle battery jump starter 300. A process 700 begins with the battery pack 100 being attached to the vehicle battery jump starter 300 (at 705). Following STEP 705, the controller 400 of the vehicle battery jump starter 300 controls the pre-charge circuit 505 to electrically connect the battery pack 100 to the power boost module 480 (at 710). After the battery pack 100 is connected to the power boost module 480, one or more parameters of the connected battery pack 100 are determined (at 712) as described in more detail above. Upon determining the parameters of the battery pack 100, stored energy from the battery pack 100 can be used to charge the power boost module 480 (at 715) based upon the determined parameters. In some embodiments, the charge control circuit 275 regulates the current discharged from the battery pack 100 as previously described. After the power boost module 480 has been fully charged, the controller 400 controls the precharge circuit 505 to electrically disconnect the battery pack 100 from the power boost module 480 (at 720). With the power boost module 480 charged and the battery pack 100 connected to the vehicle battery jump starter 300, the combination of the battery pack 100 and the vehicle battery jump starter can be used to jump start the vehicle battery 500.

The charge control circuit 275 can selectively prevent the battery pack 100 from being used to jump start the vehicle battery 500 if the voltage of the battery pack 100 is so low that attempting to jump start the vehicle battery 500 could damage the battery pack 100. For example, in addition to the allowable voltage threshold of the battery pack 100, a second allowable voltage threshold value can be implemented to prevent the battery pack 100 from being used to jump start a vehicle. In some examples, the charge control circuit 275 may prevent the battery pack 100 from discharging current when the battery pack 100's voltage is below the second threshold value and discharging current would drop the voltage of the battery pack 100 below the second allowable voltage threshold (e.g., 2.6V per cell). The second voltage threshold value is selected to correspond to the amount of energy required to jump start the vehicle battery 500 or an expected voltage reduction resulting from the discharge of the high current necessary to jump start a vehicle battery. If the battery pack 100 has less charge than would be required to jump start the vehicle battery 500 and attempting to jump start the vehicle battery 500 would cause the battery pack 100's voltage to be depleted below or fall below the standard low-voltage cutoff, charge control circuit 275 prevents the battery pack 100 from attempting to jump start the vehicle battery 500. In some embodiments, the controller 400 of the vehicle battery jump starter 300 or the controller 200 of the battery pack 100 may perform these features.

The vehicle battery jump starter 300 is then connected to the vehicle battery 500 via terminal clamps 335 and 340 (at 725). Once the vehicle battery jump starter 300 is connected to the vehicle battery 500, the controller 400 monitors the voltage across the vehicle battery 500 (at 730). When an attempt to start a vehicle is made, the voltage of the vehicle battery 500 is reduced. This reduction in voltage of the vehicle battery 500 signals to the controller 400 that an attempt to start the vehicle has been made (at 735).

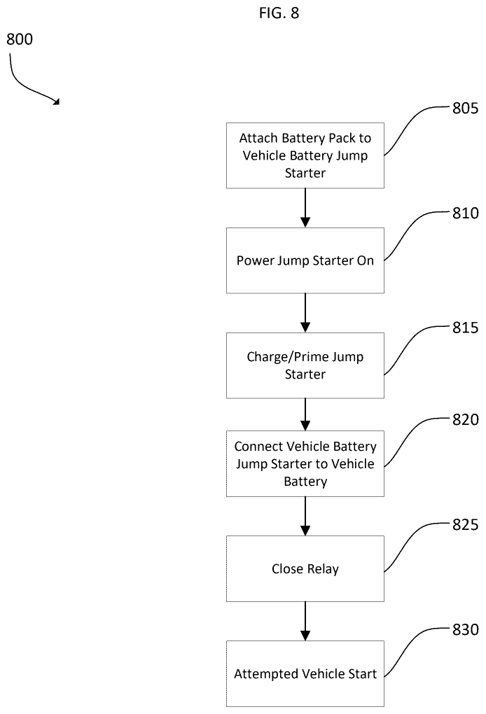

FIG. 8 is a flow chart illustrating a further operation of the combination of battery pack 100 and vehicle battery jump starter 300. A process 800 begins with the battery pack 100 being attached to the vehicle battery jump starter 300 at process block 805, and the vehicle battery jump starter 300 is powered ON at process block 810). In some embodiments, the vehicle battery jump starter 300 may be powered ON as described above, such as via a user input.

The vehicle battery jump starter may then receive an input/instruction to charge (also referred to as prime or priming) the vehicle jump starter 300 using the connected battery pack 100 at process block 815. For example, before connecting the vehicle jump starter 300 to the vehicle battery 500, the power boost module 480 may be primed using energy provided by the battery pack 100. In some examples, the user input module 425 may include a button, actuator, interface, or any other input that enables the user of the vehicle battery jump starter 300 to activate the priming of the power boost module 480. Charging the power boost module 480 may include providing power to the supercapacitors, as described above. This can allow for the vehicle jump starter to be fully charged/primed prior to being connected to the vehicle batter 500, thereby reducing time required to jump start a vehicle. In one embodiment, the user input may be the connection of the battery pack 100, such that the power boost module 480 is primed upon the battery pack 100 being connected to the vehicle jump starter 300 without any additional user input.

At process block 820, the vehicle battery jump starter 300 is connected to the vehicle battery. In some instances, the vehicle battery jump starter 300 bay be connected to the vehicle battery 500 via terminal clamps 335 and 340, as previously described. In response to the battery jump starter 300 being connected to the vehicle battery 500, the controller 400 controls the power boost module 480 to allow for power to be provided to the vehicle battery 500 at process block 825. For example, a relay or other switch may be closed to allow power to flow from the vehicle battery jump starter 300 to the vehicle battery 500. In some examples, a user may actuate an input on the device to allow power to flow from the vehicle battery jump starter 300 to the vehicle battery 500. In other example, a combination of user input and the controller 400 may both be required to allow power to flow from the vehicle battery jump starter 300 to the vehicle battery 500. For example, in response to receiving a user input, the controller 400 may evaluate one or more parameters, such as charge state of the power boost module 480, the connection to the vehicle battery 500, and/or other parameters prior to allowing for power to be provided to the vehicle battery 500. At process block 830, an attempt may be made to start the vehicle.

Thus, the technology provides, among other things, a vehicle battery jump starter powered by a removable and rechargeable battery pack.

What is claimed:

1. A vehicle battery jump starter comprising:
a controller including an electronic processor and a charge control circuit;
a battery pack interface configured to receive a removable and rechargeable battery pack; and
a power boost module including one or more energy storage devices;
wherein the power boost module is configured to be charged through the battery pack interface with a discharge current from the removable and rechargeable battery pack in response to receiving the removable and rechargeable battery pack, and
wherein the charge control circuit is configured to control the discharge current from the removable and rechargeable battery pack to the power boost module based upon one or more monitored conditions of the removable and rechargeable battery pack.

2. The vehicle battery jump starter of claim 1, wherein the charge control circuit is configured to control the discharge current from the battery pack to prevent the battery pack from being discharged below a predetermined voltage threshold.

3. The vehicle battery jump starter of claim 1, wherein the charge control circuit is configured to determine a no-load voltage of the battery pack and calculate an allowable load voltage for the battery pack based on the no-load voltage.

4. The vehicle battery jump starter of claim 1, wherein the charge control circuit is configured to monitor a voltage of the battery pack during discharge and modulate the discharge current to maintain the battery voltage at or above a predetermined voltage threshold.

5. The vehicle battery jump starter of claim 1, wherein the vehicle battery jump starter includes a communication line for providing a communication link between the controller and the battery pack.

6. The vehicle battery jump starter of claim 1, wherein the controller is further configured to prevent the battery pack from discharging a current when a voltage of the battery pack is below a predetermined threshold or when discharging current would drop the voltage below the predetermined voltage threshold.

7. The vehicle battery jump starter of claim 6, wherein the charge control circuit is configured to determine the predetermined threshold based on an impedance level of the battery pack.

8. The vehicle battery jump starter of claim 1, wherein the charge control circuit is configured to optimize the discharge current based on information including a battery pack capacity, a battery pack impedance, a state of charge of the battery pack, a state of health of the battery pack, or a temperature of the battery pack.

9. The vehicle battery jump starter of claim 1, wherein the charge control circuit is configured to:
monitor a discharge characteristic of the battery pack,
determine an optimal discharge rate for the battery pack, and
control the battery pack based upon the optimal discharge rate.

10. The vehicle battery jump starter of claim 1, wherein the monitored conditions include a prediction of battery behavior based upon a machine learning profile containing historical data from a previous use of the battery pack.

11. The vehicle battery jump starter of claim 1, wherein the controller is configured to reduce power draw of the power boost module based on a voltage of the battery pack during discharge.

12. The vehicle battery jump starter of claim 1, further comprising a user input module configured to receive an instruction to charge the power boost module prior to connection to a vehicle battery.

13. The vehicle battery jump starter of claim 1, wherein the controller is configured to electrically connect the battery pack to the power boost module and to electrically disconnect the battery pack from the power boost module after the power boost module is fully charged.

14. A method of operating a vehicle battery jump starter, the method comprising:
receiving a removable and rechargeable battery pack within a vehicle battery jump starter;
charging, via an electronic processor, a power boost module of the vehicle battery jump starter with energy from the battery pack in response to receiving the battery pack;
connecting the vehicle battery jump starter to a vehicle battery via terminal clamps;
controlling, via the electronic processor, the power boost module to allow power to be provided from the power boost module to the vehicle battery;
in response to receiving a user input to provide power to the vehicle battery, evaluating, via the electronic processor, one or more parameters of the vehicle battery jump starter, the one or more parameters comprising at least one of: a charge state of the power boost module and a connection to the vehicle battery; and
in response to the power boost module being in a charged state and the vehicle battery being in a connected state, providing power from the vehicle battery jump starter to the vehicle battery to enable an attempt to start the vehicle.

15. The method of claim 14, wherein evaluating the one or more parameters includes determining whether the vehicle battery jump starter is electrically connected to the vehicle battery via the terminal clamps and evaluating a charge state of the power boost module to determine that the power boost module is charged.

16. The method of claim 14, further comprising:
monitoring, via the electronic processor, a voltage of the battery pack during charging of the power boost module,
determining, via the electronic processor, that the power boost module is fully charged prior to disconnecting the battery pack from the power boost module, and
disconnecting, via the electronic processor, the battery pack from the power boost module after charging the power boost module.

17. A system for jump starting a vehicle battery, the system comprising:
a removable and rechargeable battery pack including a plurality of battery cells, and a battery controller configured to monitor one or more battery conditions;
a vehicle battery jump starter including a battery pack interface configured to receive and electrically connect to the removable and rechargeable battery pack, the vehicle battery jump starter further including a power boost module, an electronic processor, and a charge control circuit;
wherein the electronic processor of the vehicle battery jump starter is configured to:
receive, via the battery pack interface, the connection of the removable and rechargeable battery pack;
receive battery condition data from the battery controller via a communication link between the battery pack and the jump starter;
determine a no-load voltage of the battery pack and calculate a voltage threshold based on the no-load voltage and an impedance of the battery pack;
control a discharge current from the battery pack to the power boost module based on the voltage threshold and the one or more battery conditions in response to receiving the connection of the battery pack;
monitor the voltage of the battery pack during charging of the power boost module and modulate the discharge current to maintain the battery pack voltage at or above the voltage threshold; and
prevent discharge from the battery pack in response to the voltage of the battery pack being below the voltage threshold.

18. The system of claim 17, further comprising a precharge circuit configured to selectively connect or disconnect the battery pack from the power boost module.

19. The system of claim 17, wherein the charge control circuit is further configured to calculate the voltage threshold for the battery pack based on the no-load voltage and to limit the discharge current to maintain the battery pack voltage above the voltage threshold.

20. The system of claim 17, wherein the electronic processor is further configured to:
determine a performance level of the connected battery pack, the performance level including a high-performance or low-performance, where the determination is based on a battery pack impedance, and
control a discharge current from the battery pack to the power boost module based on the voltage threshold and the performance level of the battery pack.
